(19) United States
(12) Patent Application Publication
(10) Pub. No.: US 2008/0018995 A1
(43) Pub. Date: Jan. 24, 2008

(54) User-directed automated telescope alignment

(76) Inventor: Kenneth W. Baun, Trabuco Canyon, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/490,572

(22) Filed: Jul. 21, 2006

(51) Int. Cl. G02B 23/00

(52) U.S. Cl. 359/399; 359/430

(57) ABSTRACT

Embodiments of the present disclosure include user-directed automated telescope alignment systems and methods. In various embodiments, the automated alignment procedure provides for user-direction in selecting astronomical alignment objects. For example, in an embodiment, after the telescope is aligned according to a first approximation alignment, the user may direct the field of view of the telescope system to a viewable, sufficiently bright astronomical object. Upon bringing the object into the field of view, the alignment procedure advantageously identifies the likely astronomical object based on the first approximation alignment. The procedure also updates the first approximation alignment based on known information about the identified object. The process of user-direction to additional viewable bright astronomical objects provides for more precise and accurate mappings of telescope movements to celestial field of view.

### CROSS-REFERENCE TO RELATED APPLICATIONS

The present disclosure relates to U.S. patent application Ser. No. 11/189,005, titled “Systems And Methods For Automated Telescope Alignment And Orientation,” filed Jul. 25, 2005 [033CP1C1]; U.S. patent application Ser. No. 10/357,912, titled “Automated Telescope Alignment And Orientation Method,” filed Feb. 4, 2003 [057DV2]; U.S. patent application Ser. No. 10/358,754, titled “Automated Telescope With Distributed Orientation And Operation Processing,” filed Feb. 5, 2003 [057DV3]; U.S. patent application Ser. No. 11/296,822, titled “Systems And Methods For Aligning A Telescope,” filed Dec. 7, 2005 [057DV2C1]; U.S. patent application Ser. No. 11/110,626, titled “Self-Aligning Telescope,” filed Apr. 20, 2005 [045A]; and U.S. patent application Ser. No. 11/110,484, titled “High Definition Telescope,” filed on Apr. 20, 2005 [056A]; each of which is hereby incorporated by reference herein in its entirety.

### BACKGROUND OF THE DISCLOSURE

1. Field of the Disclosure

The present disclosure relates in general to telescope initialization and specifically to the alignment or orientation of a telescope with a celestial coordinate system to allow for the automatic or semi-automatic positioning of the telescope with respect to a desired astronomical object.

2. Description of the Related Art

Historically, some formidable challenges faced new and often even experienced astronomers from easily viewing objects in a night sky. For example, it is generally nontrivial to determine which interesting objects are available for viewing on a particular night from a particular location. Moreover, even when such interesting object information can be determined, it is also generally nontrivial to coordinate movements of an optical system such as a telescope tube to locate and to track objects defined by their position in a predefined celestial coordinate system.

With the advent of an automated telescope such as, for example, telescopes having virtually any type of electronic positioning mechanisms, manufacturers developed extensive databases of astronomical objects that can be accessed to determine which astronomical objects are currently viewable to a user. For example, one database system commercially available from Meade Instruments Corporation (“Meade”) of Irvine, Calif., includes over 5,000 galaxies, nebulae, and star clusters of all types from the Index Catalog (IC); almost 8,000 galaxies, nebulae, and star clusters of all types from the New General Catalog (NGC); over 100 objects from the Caldwell Catalog of the best objects for small telescopes; over 100 Messier (M) objects; almost 17,000 double stars, variable stars, and other stars of special note from the Smithsonian Astrophysical Observatory (SAO) catalog; about 50 Earth-orbiting satellites; over 25 asteroids, including all of the brightest asteroids; about 15 periodic comets; and all the major planets from Mercury to Pluto as well as many of their satellites. Thus, electronic database information has virtually resolved which interesting objects are available for viewing. To make the “interesting object” selection even more straightforward, manufacturers also offer sky tours using their electronic telescope to find objects listed in, for example, a “Tonight's Best™” tour, which may advantageously select the “best” objects in the sky for a particular time and location.

Generally, celestial objects may be defined by their position in a celestial coordinate system. For example, a commonly-used celestial coordinate system comprises right ascension (RA) and declination coordinates. To view and track celestial objects, measurements obtained in a telescope's coordinate system (expressed, for example, in altitude and azimuth coordinates) are converted or transformed into celestial coordinates and vice-versa. The conversion between a telescope coordinate system and a celestial coordinate system depends at least in part on an initial orientation of the telescope. Accordingly, prior to locating objects with the telescope, the user and/or the telescope system may perform an initialization and/or alignment procedure that determines how to transform positioning of the telescope's optical system to a desired celestial field of view. Alignment is sometimes referred to as orientation, and these terms will be used interchangeably unless otherwise expressly stated.

Manufacturers have developed alternatives for reducing complexities associated with an initialization and/or alignment of a telescope system. For example, Level North™ Technology, commercially available from Meade, uses processor control to determine an indication of level (e.g., horizontal) for a telescope, to determine an indication of North, and to determine time and date. The geographic location of the telescope may be determined, for example, by a user entering his or her zip code or proximity to a known city or geographic location. The processor is able to use this information to provide a conversion between its telescope coordinate system and a celestial coordinate system. However, an artisan will recognize from the disclosure herein that one or more indications of a time, date, location, level, and north may be identified and entered manually or by other methods.

Based on the accuracy of the foregoing or other initialization and/or alignment information, the telescope processor can determine a “first approximation” of alignment. Often, such first approximation is sufficient to begin finding desired objects in the sky. However, in certain cases, the user may desire to refine the alignment to more accurately and precisely define the conversion between telescope and celestial coordinates. For example, in some cases, the processor may use the first approximation to slew or direct the telescope to a first alignment star. The user may then control positioning mechanisms (electronic or other) to center the field of view over the alignment star. The user corrections are then used to “update” the first approximation. This and subsequent alignment procedures often provide more precise and accurate mappings of telescope movements to any celestial field of view. First approximation, refined approximations, and other alignment procedures are further disclosed, for example, in U.S. Pat. No. 6,392,799, titled “Fully Automated Telescope System With Distributed Intelligence,” which is hereby incorporated by reference herein in its entirety.

### SUMMARY

While the foregoing alignment procedures have made telescope alignment far more straightforward than prior manual methods, there are difficulties added to any system attempting automated detection of its positional information. For example, a telescope processor seeking to automatically align the telescope's field of view may not have helpful information about the environment and physical surroundings of the telescope. Lack of this information may cause repetitiveness, errors, or at least delay in an alignment process. For example, trees, buildings or other structures, lights, clouds, hills, mountains, or the like may block or interfere with small or significant portions of the sky, including portions desired by automated alignment procedures, such as, for example, desired astronomical alignment objects.

Thus, it is advantageous to account for a particular viewable sky in automated alignment procedures. Accordingly, in an embodiment of the disclosure, an automated alignment procedure provides for user-direction in learning about a particular sky. For example, in an embodiment, after a first approximation alignment, a user may direct a field of view of a telescope system to a viewable, bright astronomical object. Upon bringing the object into a field of view, the alignment procedure advantageously identifies the likely astronomical object based on the first approximation alignment. The procedure also updates the first approximation alignment based on known information about the identified object. In an embodiment, repetition of the same or similar process of user-direction to other viewable bright objects provides for ever more precise and accurate mappings of telescope movements to celestial field of view.

In one embodiment, a method of improving an alignment of a field of view of a telescope comprises establishing a first approximation alignment of a field of view of a telescope system and receiving an indication that a user has directed the field of view to an astronomical alignment object selected by the user from astronomical objects presently accessible. The method further comprises electronically identifying celestial coordinates for the astronomical alignment object based on the first approximation alignment, and electronically updating the first approximation alignment of the field of view based on the identified celestial coordinates.

In another embodiment of the disclosure, a telescope system that is capable of user-directed alignment comprises an optical system including a field of view and a positioning system adapted to precisely position the filed of view of the optical system. The telescope system further comprises a processor configured to determine a first approximation alignment of the field of view and to receive an indication that a user has manipulated the positioning system to cause the field of view to be directed toward an astronomical alignment object selected by the user from astronomical objects presently accessible. The processor is also configured to electronically identify celestial coordinates for the astronomical alignment object based on the first approximation alignment and to electronically update the first approximation alignment of the field of view based on the identified celestial coordinates.

In another embodiment, a processing system capable of allowing a user to select an astronomical object from a database of astronomical objects and capable of directing a field of view of a telescope to view the astronomical object is disclosed. The processing system comprises one or more inputs receiving an indication of precise movements of a field of view of a telescope system, a user input, and a processor. The processor is configured to determine a first approximation alignment of the field of view and to receive an indication that a user has manipulated the positioning system to cause the field of view to be directed toward an astronomical alignment object selected by the user from astronomical objects presently accessible. The processor is further configured to electronically identify celestial coordinates for the astronomical alignment object based on the first approximation alignment and to electronically update the first approximation alignment of the field of view based on the identified celestial coordinates. The processor is also configured to receive a user selection of a desired astronomical object from a database of astronomical objects and, using the updated first approximation alignment, to direct the field of view to view the desired astronomical object.

In another embodiment of the disclosure, a computer readable medium comprises software instructions capable of directing a processor of a telescope system, which includes a field of view, to update an alignment of a telescope. The software instructions comprise instructions that direct the processor to establish a first approximation alignment of the field of view of the telescope system. The software instructions further comprise instructions that direct the processor to receive an indication that a user has directed the field of view to an astronomical alignment object selected by the user from astronomical objects presently accessible. The software instructions also comprise instructions that direct the processor to electronically identify celestial coordinates for the astronomical alignment object based on the first approximation alignment, and instructions that direct the processor to electronically update the first approximation alignment of the field of view based on the identified celestial coordinates.

Other embodiments, features, and advantages of the present disclosure will become apparent to a skilled artisan through consideration of the following detailed description, the accompanying drawings, and the appended claims. Accordingly, neither this summary nor the following detailed description is intended to limit the scope of the disclosure.

### BRIEF DESCRIPTION OF THE DRAWINGS

Systems and methods that embody various features of the disclosure will now be described with reference to the following drawings.

FIG. 1 illustrates an exemplary telescope having a processor controlled positioning mechanism, according to an embodiment of the disclosure.

FIG. 2 illustrates an exemplary block diagram of a telescope control system according to an embodiment of the disclosure.

FIG. 3 illustrates a block diagram of a first approximation alignment procedure according to an embodiment of the disclosure.

FIG. 4 illustrates a flow chart of a user-directed alignment procedure according to an embodiment of the disclosure.

### DETAILED DESCRIPTION OF CERTAIN PREFERRED EMBODIMENTS

Embodiments of the present disclosure provide systems and methods by which a user can direct alignment of a field of view of a telescope tube with respect to the celestial sphere. To perform the alignment, in certain embodiments the user directs a telescope control system to move the telescope tube to point toward a celestial object that is viewable in the sky. The user can utilize his or her knowledge of the night sky to select the celestial object. Beneficially, the user can choose a celestial object whose view is not blocked by, for example, trees, buildings, terrain, and the like and whose view is not impeded by, for example, light pollution, fog, clouds, etc. The user preferably directs the telescope control system to center the celestial object within the field of view of the telescope tube. In some embodiments, the telescope control system identifies the celestial object and its celestial coordinates by, for example, searching a celestial object database stored in a memory of the control system. The telescope control system then maps the telescope's coordinate system to the celestial coordinate system. Once mapped, the user can direct the telescope control system to point the telescope tube toward any desired celestial object in the viewable sky. Additionally, in certain embodiments, the telescope control system can use the mapping to track the desired celestial object as it moves across the night sky due to the Earth's rotation. Accordingly, embodiments of the user-directed telescope alignment systems and methods advantageously provide the user with a “hands-on” observing experience that utilizes the user's knowledge and understanding of the particular sky viewable from the telescope.

In certain embodiments, the user can choose to improve the accuracy of the foregoing user-directed telescope alignment process. For example, the user can direct the telescope control system to slew the telescope tube to an additional viewable celestial object and then to center the object within the field of view. The telescope control system identifies the object and updates and refines the mapping between the telescope coordinate system and the celestial coordinate system. The user can direct the control system to repeat the alignment process until the user is satisfied with the alignment of the telescope.

In certain embodiments, the user can establish a first approximation to the alignment of the telescope with respect to the Earth. For example, in one embodiment the user inputs the date, time, and terrestrial location (e.g., longitude and latitude) of the telescope into the control system. The user also determines the orientation of the telescope with respect to the Earth. For example, in certain embodiments the user can establish the telescope's orientation by directing the control system to move the telescope to a level plane (e.g., horizontal) and to magnetic North. The control system can use the date, time, location, and orientation information to determine a first approximation for a mapping of telescope coordinates to celestial coordinates. If the user desires to improve the first approximation telescope alignment, the user may proceed according to the above user-directed alignment process. Once the user is satisfied with the telescope alignment, the user can direct the telescope to proceed with normal telescopic observations including, for example, locating and/or tracking desired celestial objects and then viewing and/or imaging the celestial objects.

To facilitate a complete understanding of user-directed automated telescope alignment systems and methods, the remainder of the detailed description describes certain preferred embodiments with reference to the drawings, wherein like reference numbers are referenced with like numerals throughout. The detailed descriptions of the preferred embodiments of user-directed automated telescope alignment do not represent the only form in which the disclosure may be constructed or utilized. Those having skill in the art will understand from the disclosure herein that the same or equivalent functionality to that disclosed may be accomplished by various modifications to the embodiments without departing from the spirit and scope of the invention. The disclosure and the drawings may describe certain aspects, advantages, and benefits of certain embodiments. However, it is understood that not every embodiment need incorporate every aspect or advantage described herein, and that certain embodiments may emphasize or optimize one (or more) aspect or advantage as compared to other aspects or advantages.

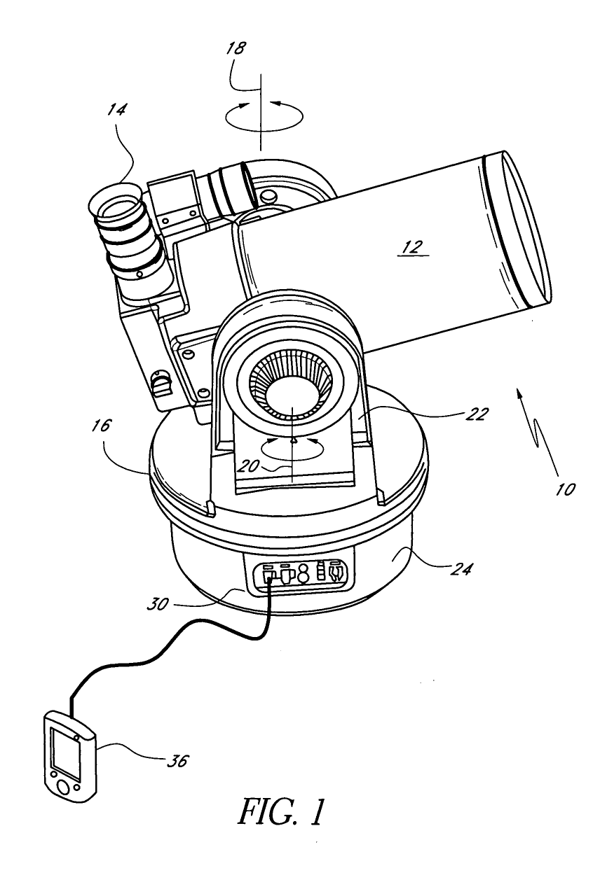

In FIG. 1, an embodiment of a telescope system 10 for observing celestial and terrestrial objects is provided in accordance with the present invention. The telescope system 10 suitably comprises a telescope tube 12 which houses an optical system for imaging and/or resolving distant objects and including a focusing objective and eyepiece 14 coupled to the optical system in a manner to allow observation of the optical system's focal plane. The eyepiece 14 typically comprises one or more lenses that are used to provide suitable optical magnification and to provide a suitable field of view. The telescope tube 12 is supported by a mount 16 which facilitates movement of the telescope tube 12 about two substantially orthogonal axes such as, for example, a substantially vertical axis, termed an azimuth axis 18, and a substantially horizontal axis, termed an altitude axis 20. As those having skill in the art will appreciate, the horizontal and vertical axes of the mount 16 in combination define a gimbaled support for the telescope tube 12 enabling it to pivot in a horizontal plane defined by the vertical (or azimuth) axis and, independently, to pivot through a vertical plane defined by the horizontal (altitude) axis.

Although FIG. 1 illustrates use of an eyepiece 14 with the telescope system 10, in other embodiments other optical components can be used such as, for example, a camera, a spectroscope, or a photometer. In certain embodiments, an electronic imager comprising, for example, a digital camera, a charge coupled device (CCD) camera, a complimentary metal oxide semiconductor (CMOS) image array, or the like can be used instead of or in addition to the eyepiece 14. The electronic imager may be coupled via wired and/or wireless techniques to an output device configured to display a suitable image. Thus, in some embodiments, images of celestial objects provided by the electronic imager can be viewed on a display screen, computer monitor, television set, cellular telephone, personal digital assistant (PDA), or other suitable output device. In various embodiments, the system 10 may include a data storage device (such as, e.g., RAM or flash memory) that can be used to store data, images, program instructions, user information (e.g., geographic position), and the like. Additionally, the system 10 may include a focusing unit that can adjust the focus of the optical system housed within the tube 12. The focusing unit may comprise a conventional manual focus control knob geared to adjust the position of the eyepiece 14 relative to the telescope optics, or the focusing unit may comprise an electronic focusing system adapted to electronically adjust the focus of the optics, e.g., via a focus motor.

It should be noted, at this point, that the telescope system 10 is illustrated as comprising a telescope tube 12 configured as a reflecting-type telescope. However, the form of the telescope's optical system, per se, is not particularly relevant to practice 6f principles of the present invention. Thus, even though depicted as a reflector, the telescope system 10 of the present invention is eminently suitable for use with refractor-type telescopes. The specific optical systems used might be Newtonian, Cassegrain, Schmidt-Cassegrain, Maksutov-Cassegrain, and any other conventional reflecting, refracting, or catadioptric optical system configured for telescopic use.

In the telescope system embodiment 10 illustrated in FIG. 1, it is convenient to support the telescope tube 12 and mount 16 combination in such a manner that the vertical axis 18 is, indeed, substantially vertical such that the telescope pivots (or rotates) about the vertical (azimuth) axis 18 in a plane which is substantially horizontal. Additionally, it is convenient to support the telescope tube 12 and mount 16 combination in such a manner that the horizontal (altitude) axis 20 is, indeed, substantially horizontal such that the telescope pivots (or rotates) about the horizontal axis 20 in a plane which is substantially vertical. Accordingly, the telescope system 10 shown in FIG. 1 comprises an “alt-azimuth” telescope system configured to point the telescope optics toward a suitable object by pivoting the telescope tube 12 about the azimuth axis 18 and the altitude axis 20. However, a skilled artisan will recognize that other mounting systems can be used to point the telescope optics towards desired objects. For example, in other embodiments, the telescope system 10 may be a “polar” or “equatorial” telescope in which the mounting system provides rotation about an azimuth axis and a polar axis that points to the North (or the South) celestial pole. For example, in one embodiment, the mount 16 can be tilted so that its plane is parallel to the Earth's equatorial plane so as to provide an equatorial configuration.

A tripod (not shown in FIG. 1) conventionally functions to support the mount 16 such that the azimuth axis 18 is substantially orthogonal to a horizontal plane, relative to a user of a telescope system. In some embodiments, the tripod includes three legs, which are arranged in a triangular pattern. Each of the legs can be independently adjustable for leveling the mount 16 regardless of the nature of the surface on which the telescope system 10 is used. In other embodiments, the mount 16 is supported by a pedestal or pier or simply placed on a convenient, suitably level surface. In certain equatorial or polar configurations, the tripod is configured to secure the base 16 so that it is parallel to the Earth's equatorial plane.

In some embodiments, the telescope system 10 of FIG. 1 is a manual, non-automatic embodiment in that the telescope tube 12 is pivotally moved about the azimuth axis 18 and altitude axis 20 by a user's grasping and manually moving an axially mounted azimuth control knob and an axially mounted altitude control knob. In one embodiment, each of the control knobs and is journaled to respective axis pins through a conventional gearing system such that small and precise movements of the telescope tube 12 may be made about the azimuth and altitude axes 18 and 20 by relatively large rotations of the control knobs. In such embodiments, the telescope system 10 of FIG. 1 resembles a conventional, manually operated telescope system.

However, in certain preferred embodiments, the telescope system 10 comprises one or more motors configured to move (or slew) the telescope tube 12 so as to locate and/or track celestial objects. In some embodiments, the telescope system 10 comprises an azimuth motor configured to pivot or rotate the telescope tube 12 about the azimuthal axis 18 and an altitude motor configured to pivot or rotate the telescope tube 12 about the altitude axis 20. The motors can be, for example, DC servo or stepper motors. The motors can be configured to slew the telescope tube 12 at one or more user-selectable rates such as, for example, the sidereal rate. The telescope system 10 may include one or more motion feedback evaluation devices, such as optical, mechanical, or magnetic encoders, that are coupled to the axes 18, 20 (and/or the motors) and configured to measure the actual travel of the telescope system 10, preferably in both the azimuth and altitude planes (or the azimuth and equatorial planes in a polar mount). A skilled artisan will recognize that particulars relating to the configuration, operation, and control of the motors and the motion feedback devices are not integral to the present invention and that movement of the telescope tube can be achieved in many well-known ways.

In addition to supporting telescope motion about two orthogonal axes, in certain embodiments the mount 16 is constructed to include an electrical interface junction panel 30 which allows various electronic components comprising the telescope system to be interconnected and to support interoperability. The electrical interface junction panel 30 is configured to support upgradeability of the telescope system 10 to an intelligent automatic telescope system in a series of logically consistent steps, each of which results in a functional telescope system having a greater or lesser degree of intelligence and/or functionality, depending upon where, along the upgrade spectrum, a user would achieve the most subjectively desirable ratio of system complexity as a function of functional benefit.

In certain embodiments, the motors for the azimuth axis 18 and the altitude axis 20 are at least partially external from the mount 16 and can be electrically coupled to the telescope system 10 through the electrical interface junction panel 30. The electrical interface junction panel 30 allows motor control signals to be directed to each of the motors, the motor control signals providing speed and direction information to an electronics package which, in turn, provides appropriate activation signals to the respective motors.

In one embodiment, a user plugs or otherwise electrically connects a hand-held system control unit 36 into an appropriate receptacle of the electrical interface junction panel 30 and further plugs (or otherwise electrically connects) azimuth and altitude motors connectors into respective receptacles, thus completing a signal path between each of the motors and the system control unit 36. Motion commands are provided to the system by the user, by accessing the appropriate function provided on the hand-held system control unit 36. Signals corresponding to the desired motion are directed by the control unit 36 to the appropriate motor through the electrical interface junction panel 30. For example, if a user desires to slew the telescope in a counter-clockwise direction, he may enter a command into the control unit 36 telling the telescope system to move “left”. In response, the azimuth axis motor is commanded to activate its integral motor in order to rotate the telescope in a particular direction, thus causing the telescope mount to pivot in a counter-clockwise fashion about the azimuth axis 18. In like manner, when a user desire to elevate the telescope 12 in an upwardly direction, the user would enter the appropriate “up” command into the control unit 36 thus activating the altitude motor which, in turn, causes the telescope to pivot upwardly about the altitude axis 20. The control unit 36 can be used further to direct the stewing of the motors at the proper slew rate by evaluating the speed of axial displacement (e.g., from the motion feedback evaluation devices) and controlling motor speed correspondingly.

Returning momentarily to the exemplary telescope embodiment of FIG. 1, it should be understood that the telescope system 10 depicted therein comprises an integrated telescope such that the altitude and azimuth motors are disposed within a vertically positioned fork arm 22 and a telescope mount base 24, respectively. Accordingly, the azimuth and altitude motors do not connect to the electrical interface junction panel 30 in the particular embodiment of FIG. 1. For example, motor wiring is accommodated internal to the structure of the mount (including the fork arm 22 and base 24) and the systems electronic components are packaged accordingly. In the embodiment shown in FIG. 1, motion commands are communicated to the integrated motors via the control unit 36 in a manner similar to that described above. In other embodiments, the control unit 36 is integrated into the system 10 rather than being a separate unit. In preferred embodiments, the control unit 36 is a portable hand-held paddle comprising an output display, motion control buttons, and other input buttons. In one embodiment, the control unit 36 comprises a touchscreen that combines, at least in part, the output display, input buttons, and/or motion control buttons. In some embodiments, the control unit 36 is electrically connected to the electrical interface junction panel 30 via a wired connection (e.g., as shown in FIG. 1). In other embodiments, the control unit 36 wirelessly communicates with the telescope system 10. Some wireless embodiments advantageously permit the user to control the telescope system 10 from a generally greater distance than when a wired connection is used. The control unit 36 may be configured to utilize and/or be compatible with astronomical software suites such as, for example, the AutoStar™ or AutoAlign™ packages available from Meade.

The electrical interface junction panel 30 further allows for signal communication between each respective one of the motors and other electronic components including, for example, the hand-held system control unit 36, a display, an electronic imager control unit, a focus control unit, an image storage device, additional processors, a wireless communications unit, a timing device, a magnetic compass, or any other suitable component. In certain embodiments, electronic components may communicate with the telescope system 10 (and/or with each other) via wireless techniques, thereby eliminating the need to physically connect various components to the telescope system 10 through the interface junction panel 30.

The telescope system 10 can comprise additional components as well. For example, some embodiments comprise one or more level sensors that are used to determine the orientation of the telescope tube 12 with respect to a horizontal position. Embodiments also can include a magnetic compass that can determine the orientation of the telescope tube 12 with respect to magnetic North. In an exemplary embodiment, the level sensor comprises an accelerometer such as a dual axis accelerometer, part number MXD2020E/F, available from MEMSIC, Inc. of North Andover, Mass. In addition, or in another exemplary embodiment, the magnetic compass comprises, for example, an electronic compass comprising a magneto-inductive sensor, part number SEN-L, available from Precision Navigation, Inc. of Santa Rosa, Calif. However, an artisan will recognize from the disclosure herein that other level sensing devices and electronic compass devices could be used.

In certain embodiments, the telescope system 10 is configured to interface with peripheral devices to assist aligning the optical system. The peripheral devices may include, for example, a global positioning satellite (GPS) receiver configured to accurately indicate the longitude and latitude of the telescope system 10 and/or a clock configured to accurately indicate the date and time. It should also be understood that a GPS receiver is able to provide timing signals which can function as precision timing reference signals. Thus, coupling a GPS receiver to the telescope system 10 provides coordinated timing data and user position data from a single device. Thus, these parameters may advantageously be determined without manual entry. In some embodiments, any or all of the peripheral devices are configured to communicate with the telescope system via the electrical interface junction panel 30; however, in other embodiments, the peripheral devices communicate with the system via wireless techniques and devices, including, for example, the control unit 36.

In certain preferred telescope systems 10, the control unit 36 comprises one or more processors configured to implement instructions that assist initialization and alignment of the telescope system 10, as well as location and tracking of celestial objects. However, in some embodiments, additional processors may be disposed elsewhere in the system 10, for example, in motors, motion feedback evaluation devices, level sensors, electronic compass, etc. In yet other embodiments, the system 10 is configured to communicate with a local and/or remote data network, including a local- and/or wide-area-network and/or the Internet, and some of the processing functions may be performed by remote processors. Accordingly, the control of the telescope system 10 in some embodiments is distributed among one or more processors that can be local and/or remote from the system 10. In preferred embodiments, the telescope system 10 includes one or more databases (e.g., celestial object databases, geographic databases, etc.), and these databases may be stored in memory devices disposed in and/or remote from the system 10. The memory devices can include any suitable data storage device such as, for example, random access memory (RAM), read-only memory (ROM), flash memory, hard drives, optical drives, magnetic drives, tapes, etc.

Although the exemplary telescope system 10 is disclosed with reference to its preferred and alternative embodiments, the disclosure is not limited thereby. Additional details of the mechanical and electrical configuration of certain exemplary telescope systems 10 can be found in the above-incorporated U.S. Pat. No. 6,392,799 and U.S. patent application Ser. No. 11/189,005. An artisan will recognize from the disclosure herein that particulars of, for example, encoding motor movements of the telescope system 10 are not integral to the present disclosure. In addition, an artisan will recognize a wide number of alternatives for the telescope, including optical viewing devices including academic, governmental, or research installations to personal magnification devices, dome-mounted devices, all manner of telescope devices, or the like. The telescope may be used from within a house, building, or other structure and may be controlled or operated locally or remotely (e.g., via commands communicated over a network such as, e.g., the Internet). The telescope may be used for personal, educational, professional, governmental, and/or research purposes.

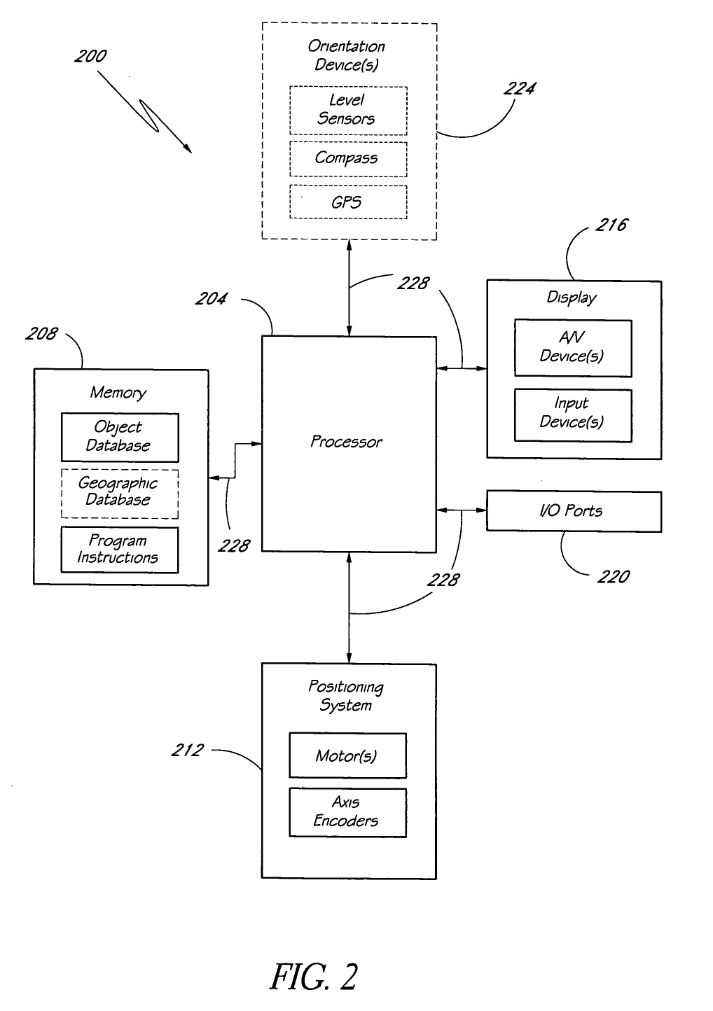

FIG. 2 schematically illustrates an exemplary block diagram of a telescope control system 200. The control system 200 comprises a processor 204, a memory 208, a positioning system 212, a display 216, and input/output (I/O) ports. Additionally and optionally, the control system 200 may include one or more orientation devices 224. The processor 204 is configured to communicate with the other components so as to send and/or receive data, commands, and/or instructions via communication paths 228. In some instances, the communication paths 228 are unidirectional; however, it is preferable to provide for bidirectional communication. In many embodiments, the processor 204 communicates with the other components via wired connections; however, in some embodiments, the processor 204 is configured for wireless communication with some or all of the other components. Although FIG. 2 schematically illustrates only the processor 204 communicating with various components (e.g., via the communications paths 228), an artisan will recognize that additional and/or different communication paths (wired and/or wireless), direct or through one or more communication networks or mediums, can be established between any of the components shown in FIG. 2.

In some embodiments, some or all of the components shown in FIG. 2 may be fabricated on one or more printed circuit boards. For example, in a preferred embodiment, the control system components are disposed within the hand-held system control unit 36. However, in other embodiments, some or all of the components are distributed throughout the telescope system 10 (e.g. in motor drive systems, encoder systems, display systems, etc.), and some components may even be remote from the system (e.g., a remote computer or display device). The control system 200 may optionally include a communications module (not shown in FIG. 2) configured to communicate data, commands, and/or instructions with a wired and/or wireless data network including, for example, a local- and/or wide-area network and/or the Internet. In some embodiments, the communications module utilizes a wireless network standard such as, for example, IEEE 802.11x, Bluetooth®, or any other suitable standard.

In various embodiments, the processor 204 comprises one or more microprocessors, microcontrollers, microcomputers, signal processors, programmable gate arrays, and/or other suitable processing devices. In some embodiments, the processor 204 includes a computer or server. The processor 204 is in communication with the memory 208, which comprises any suitable type of data storage device including, for example, RAM, ROM, flash memory, electrically erasable programmable ROM (EEPROM), magnetic drives, optical drives, and tape drives. Although the memory 208 is schematically shown in FIG. 2 as a separate from the processor 204, it is recognized that various processors include integrated memory and storage devices. Accordingly, the memory 208 may be distributed throughout the control and/or telescope system 200, 10.

The memory 208 may be configured to store information including, for example, program instructions, system commands, control logic, initialization and alignment data, user data, one or more databases, and object images. Program instructions may include software, hardware, and/or firmware instructions, executable programs, dynamic libraries, object code, and the like, and may be written in, for example, compiled, interpreted, and/or machine computer languages. Preferably the processor 204 is configured to utilize the information stored in the memory 208 so as to perform suitable telescope control and operations functions as further described herein, including but not limited to, telescope initialization and alignment and object location and tracking. Additionally and optionally, the processor 204 may execute program instructions to provide further user-desired functionality such as, for example, focusing control, image acquisition and image processing, and the like. In some embodiments, the memory 208 is used to store astronomical software packages that can be executed on the processor 204. Suitable software packages include, for example, the AutoStar™ or AutoAlign™ packages available from Meade. In certain preferred embodiments, the information stored in the memory 208 is user-accessible and can be updated and/or upgraded.

The memory 208 may include one or more databases of information relating to, for example, celestial objects and geographic location. In some embodiments, the memory 208 includes at least one object database of the celestial coordinates (expressed, for example, in right ascension and declination or other well known coordinate systems) of known celestial objects that might be of interest to an observer and/or that are useful to align the telescope system 10. For example, the object database may include celestial coordinates and intensities (or magnitudes) of an alignment star or a group of alignment stars. The object database may also define a pattern made by at least one group of alignment stars. For example, the database may include relationship information for the group of alignment stars such as brightness relative to one another, angular distances to one another, angles between each other, combinations of the foregoing, or the like. A skilled artisan will recognize that although stars can be used for alignment, other celestial objects such as planets, satellites, asteroids, galaxies, and nebulae can also be used for some or all of the alignment operations.

The memory 208 may optionally include, for example, a database of the geographical coordinates (e.g., latitude and longitude) of a large number of geographical landmarks. These landmarks might include known coordinates of cities and towns, geographic features such as mountains, and might also include the coordinates of any definable point on the Earth's surface whose position is stable and geographically determinable. Thus, a user can estimate the position of the telescope system 10 with respect to the Earth by referencing a nearby geographical landmark in the geographic database. As discussed below, in other embodiments, location information is provided automatically from a global positioning system (GPS) receiver. In certain embodiments, one or more of the databases stored in the memory 208 are user accessible such that additional entries of particular interest to a user might be included.

In an exemplary embodiment, the control system 200 includes the positioning system 212 which comprises one or more motors (e.g., an azimuthal motor and an altitude motor). The positioning system 212 may also include one or more motion feedback evaluation devices, such as optical, mechanical, and/or magnetic encoders, that are coupled to the axes (and/or motors) and configured to measure the actual travel of the telescope system 10, preferably in both the azimuth and altitude planes (or the azimuth and equatorial planes in a polar mount). Thus, the position of each axis (and the telescope aspect) is determinable with respect to an initial position. The processor 204 may be configured to provide commands to the positioning system 212 to cause the motors to move the telescope tube 12 so as, for example, to align the system 10 or to locate and/or track a celestial object. The positioning system 212 preferably is configured so that the motors can slew the telescope tube 12 at one or more suitable rates including, for example, a sidereal rate, a solar rate, and one or more object acquisition rates (such as a fast rate to rapidly locate a neighborhood of the object and a centering rate to center the object within the field of view).

The control system 200 also includes a display 216 which may comprise one or more audio/visual (A/V) devices. The A/V devices may include, for example, any suitable visual output device such as a monitor, a television, a liquid crystal display (LCD), a plasma display, a printer, a device for generating hard or soft copies of images or data, and combinations of such devices. In certain embodiments, the visual output device is wirelessly connected to the control system 200, and in some embodiments comprises a cell phone, personal digital assistant (PDA), computer, etc. In some embodiments, audio output devices are included such as speakers, a voice synthesis module, and the like, which may, for example, audibly notify the user when certain desired celestial objects have been acquired by the telescope system 10. Audio output devices can also be used to provide a narrative description of suitable objects in the night sky.

The display 216 may also include one or more input devices that can be used to enter data into the control system 200. In a preferred embodiment, the display 216 comprises a touchscreen that can visually output information as well as accept user input by, e.g., pressing a touch sensitive portion of the screen. Additional or different input devices can be used such as, for example, a keyboard, a keypad, a joystick, a mouse, a voice recognition system, or other suitable data input component. In some embodiments, a remote device that is in wired or wireless communication with the control system 200 can be used to input data and/or commands. For example, in certain embodiments, the control system 200 is accessible over a data network (such as the Internet), and a user can provide suitable commands to the telescope system 10 from a remote observing location. In certain such embodiments, the display 216 may comprise the user's personal computer, laptop computer, cell phone, PDA, television, or combinations of such devices.

The control system 200 may also include one or more I/O ports that can be used to connect one or more peripheral devices to the telescope system 10. In a preferred embodiment, the I/O ports are included in the electrical interface junction panel 30. The I/O ports can be any suitable interface, port, and/or adaptor including, for example, serial or parallel ports, RS-232, universal serial bus (USB), FireWire®, small computer systems interface (SCSI), flash memory port, and an Ethernet or network adaptor. The I/O ports can also provide a suitable connection for a transceiver such as a wireless access point (WAP) so as to link system devices into a wireless network. The I/O ports may also be used to connect other peripheral devices such as, for example, a digital camera, a display monitor, external memory devices (e.g., CD or DVD devices), an electronic focusing system, a laser configured to emit laser light in the direction of the subject being observed, an audio input and/or output device, a joystick or other controller configured to manually drive the positioning system motors, a speech recognition module along with an associated audio output module, an automatic alignment tool (tube leveler and/or axis planarizer), a photometer or spectrometer, an autoguider, a reticle illuminator, a cartridge reader station (e.g., for courseware, revisions, new languages, object libraries, data storage, or the like). A skilled artisan will recognize that some or all of the above-mentioned devices may be integrated into the control system 200 and/or telescope system 10 in various embodiments so as to provide the user with a suitable selection of telescopes to meet his or her needs and budget.

The control system 200 optionally may include one or more orientation devices 224 such as, for example, a level device, an electronic compass, and/or a GPS receiver. A level device can be used to determine the inclination of, for example, portions of the telescope system 10. A skilled artisan will recognize that the level device can include, for example, one or more accelerometers and/or inclinometers. In a preferred embodiment, the level device is used to measure a tip and a tilt of the mount 16 with respect to a level plane (e.g., horizontal). The electronic compass can be used to determine the direction of magnetic North (and with suitable corrections, true North), and in some embodiments comprises a magnetoresistive sensor. The GPS receiver can be used to accurately indicate the longitude and latitude of the telescope system 10. Additionally, in some embodiments the GPS receiver is able to provide timing signals which can function as precision timing reference signals. Thus, coupling a suitable GPS receiver to the telescope system 10 provides not only coordinated timing data but also user position data from a single device. In other embodiments, the orientation devices may include a sufficiently accurate timing device configured to indicate the local time and date. The timing device may include a sufficiently accurate clock and/or a radio receiver configured to receive broadcast timing signals (e.g., the WWV channel broadcast by the National Institute of Standards and Technology). In embodiments comprising one or more of the above orientation devices, or a suitable combination of the same, some or all of the telescope alignment and orientation parameters may advantageously be determined and entered into the telescope system 10 with reduced or no intervention by the user.

Although the control system 200 is disclosed with reference to certain preferred and alternative embodiments, the disclosure is not limited thereby. Rather, an artisan will recognize from the disclosure herein a wide number of alternatives for control systems 200, including alternative devices performing a portion of, one of, or combinations of the functions and alternative functions disclosed herein. Further, an artisan will recognize that the exemplary control system 200 illustrated in FIG. 2 may be configured differently than shown and may contain additional and/or different components and devices while achieving some or all of the above-described functions and alternative functions. Further details of a control system can be found, for example, in the above-incorporated U.S. patent application Ser. No. 11/110,626.

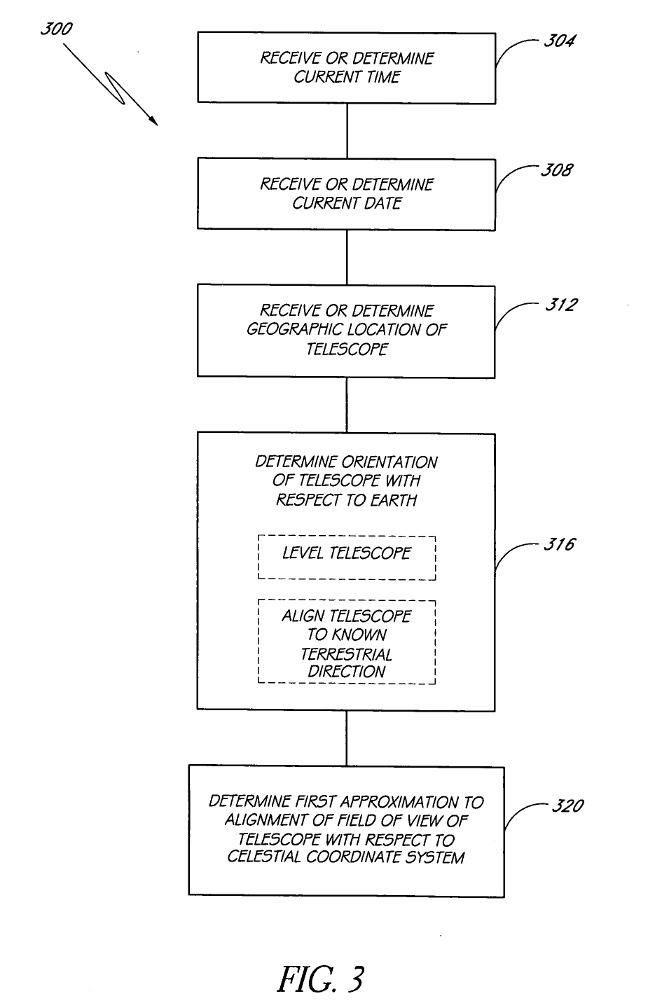

In certain embodiments of the user-directed automated telescope alignment methods discussed herein, an initial or “first approximation” to the alignment of the telescope is established. A skilled artisan will recognize that a user may adopt any well-known method for establishing an initial, approximate telescope alignment. FIG. 3 illustrates a block diagram of one example embodiment of a first approximation telescope alignment process 300. The first approximation alignment process 300 is usable by a telescope system, such as the telescope system 10 shown in FIG. 1. The first approximation alignment process 300 comprises, in short, receiving or determining a current time, current date, and an approximate geographic location of a telescope, determining an orientation of the telescope with respect to the Earth (e.g., via leveling and pointing North), and determining a first approximation for the alignment of the telescope's field of view with respect to a celestial coordinate system (e.g., RA and declination).

Referring to FIG. 3, the approximate alignment process 300 includes receiving or determining a current time in block 304, a current date in block 308, and an approximate geographic location of the telescope in block 312. As discussed above, in certain embodiments, information related to the time, date, and/or geographic location is provided by a GPS receiver. In other embodiments, the current time and date and/or approximate geographic location of the telescope may be received directly from a user, other peripheral devices (e.g., a clock or a WWV receiver), or the like. In certain embodiments, the user provides this information via, for example, one or more input devices (e.g., touchscreen, keypad, keyboard, etc.) in the display 216 of the control system 200. In some embodiments, the geographic location of the telescope may be determined, for example, by a user entering his or her zip code or proximity to a known city or geographic location, from which the control system 200 can determine an approximate latitude and longitude from a geographic database stored in the memory 208.

Generally, at the beginning of an observing session the telescope is in an unknown orientation with respect to the Earth. For example, as discussed above, a user may set the telescope system 10 on the ground or on a tripod without precision leveling of the telescope. Thus, the telescope may be tilted in a first direction and tipped in a second direction such that the rotation axes of the telescope system 10 form angles with the horizon. The user may also set the telescope on the ground or on the tripod without pointing the telescope at any particular object (e.g., the North star or another known celestial object) or in a known direction (e.g., with respect to the north pole or the south pole).

Accordingly, at block 316, the approximate alignment process 300 includes determining an orientation of the telescope with respect to the Earth. In certain embodiments, the user provides this telescope orientation information by directing the altitude and azimuth motors to level the telescope tube 12 so that its optical axis is parallel to the horizon and to point the telescope tube 12 toward North (or South in the southern hemisphere). In certain preferred embodiments, the user may indicate to the control system 200 when the telescope tube 12 has been leveled and pointed North by, for example, pressing buttons or keys on the hand-held system control unit 36. This “level-north” position thereby becomes a reference position (or origin) for the orientation of the alt-azimuth telescope coordinate system. Further details of this “level-north” method are discussed in, for example, the above-incorporated U.S. Pat. No. 6,392,799.

In certain embodiments, orientation of the telescope with respect to the Earth (block 316) is determined without additional input from the user. In certain such embodiments, the orientation devices 224 of the control system 200 comprise one or more level sensors and one or more electronic compasses. The telescope control system 200 is configured to determine the tip and the tilt of the telescope tube 12 (with respect to the horizon plane) using one or more electronic signals from these orientation devices 224. In one embodiment, the control system 200 measures the difference between the direction that the telescope tube 12 is pointing relative to the horizon in one plane and a compass direction in another plane. For example, the control system 200 receives a first signal from a level sensor positioned with respect to the telescope tube 12 such that it indicates when the tube 12 is approximately level with the horizon. In certain embodiments, additional measurements increase accuracy of the orientation determination. In such embodiments, the telescope tube 12 may be rotated approximately 180° about the azimuth axis 18. The control system 200 receives a second signal from the level sensor. By taking level measurements about 180° apart, errors in the direction above the horizon cancel, at least partially, with errors in the direction below the horizon. Thus, an accurate measurement of the tilt of the telescope mount 16 can be acquired.

In certain embodiments, the control system 200 causes the telescope tube 12 to rotate approximately 90° about the azimuth axis 18, and a third signal is received from the level sensor. By taking a level measurement about 90° from the other level measurements, an accurate measurement of the tip of the telescope mount 16 can be acquired. Thus, the “virtual” location of the telescope with respect to the Earth is determined. In certain embodiments, the control system 200 receives a fourth signal from an electronic compass, which is positioned with respect to the telescope tube 12 such that it indicates the direction that the tube 12 is pointing in the azimuth plane with respect to magnetic north, for example. Accordingly, after these measurements have been automatically performed by the control system 200, the process 300 has determined the orientation of the telescope tube 12 with respect to the Earth (e.g., tip, tilt, and direction with respect to magnetic North). Further details of this automatic “virtual” leveling procedure are described in the above-incorporated U.S. patent application Ser. No. 11/110,626.

If the user is dissatisfied with the accuracy of the determinations in some or all of blocks 304-316, the user may repeat the above acts until sufficiently accurate information (e.g., current time, current date, geographic location, and telescope orientation) has been provided to the control system 200. The control system 200 uses the information from blocks 304-316 to determine in block 320 a transformation or conversion between the telescope coordinate system (e.g., altitude and azimuth) and the celestial coordinate system (e.g., RA and declination). A skilled artisan will recognize that the control system 200 can utilize many well-known algorithms for performing the coordinate system conversion in block 320. At this point, the first approximation telescope alignment process 300 is complete, and the telescope control system may advantageously slew the field of view of the telescope tube 12 so as to approximately point to any set of celestial coordinates. However, in certain embodiments, such measurements and information include approximations and measurement errors and are not sufficiently accurate so as to allow the telescope control system to center the telescope's field of view on a selected celestial object.

Various methods are known that can be used to refine the approximate telescope alignment provided by initialization procedures such as, for example, the process 300. For example, in some cases, the control system 200 may use the first approximation to slew or direct the telescope to a first alignment star. The user may then control positioning mechanisms (electronic or other) to center the field of view over the alignment star. The user corrections are then used to “update” the first approximation. In other refinement methods, the control system 200 slews the telescope to a first alignment area, images the field of view in the alignment area, and then processes the image (e.g., using relative star brightness, position, etc.) to identify the celestial coordinates of the alignment area and update the alignment approximation. In yet other refinement methods, the control system 200 slews the telescope to an alignment star and then tracks the “drift” of the star through the telescope's field of view to provide updated alignment information. Further details relating to these refinement methods are described in, for example, U.S. Pat. No. 6,392,799, U.S. Pat. No. 6,922,283, U.S. patent application Ser. No. 11/110,626, and U.S. patent application Ser. No. 11/189,005, each of which was incorporated by reference above.

However, these (and other) automatic or semi-automatic refinement methods suffer from disadvantages. For example, a telescope control system seeking to automatically align the telescope's field of view may not have helpful information about the environment and physical surroundings of the telescope. Lack of this information may cause repetitiveness, errors, or the like in alignment procedures. For example, trees, buildings or other structures, lights, light pollution, clouds, fog, hills, mountains, or the like may block or impair viewing of small or significant portions of the sky, including portions desired by automated alignment procedures, such as, for example, desired astronomical alignment objects. Although a user at the observing site might be readily able to identify a suitable alignment object in a clear and accessible portion of the night sky, many of the above refinement methods typically do not permit user input in the automatic refinement process. Users can become frustrated while an automated process causes the telescope to slew back and forth unsuccessfully trying to identify an alignment star, when the user can easily look upward and locate a suitable alignment object.

Additionally, many users (especially more experienced amateur astronomers) prefer a more “hands-on” approach to the telescope initialization and alignment process. By fully automating the alignment process, and thereby taking the user out of the loop, these automated processes do not take advantage of the user's skill and knowledge of the night sky. Accordingly, there is a need to provide for systems and methods that provide for user direction in the selection, identification, and acquisition of suitable alignment

Thus, a need exists to include user-acquired information about a particular viewable sky in automated alignment procedures. Accordingly, in an embodiment of the disclosure, an automated alignment procedure provides for user-direction in selecting astronomical alignment objects. For example, in an embodiment, after a first approximation alignment, a user may direct the field of view of a telescope system to a viewable astronomical object. Upon bringing the object into a field of view of the telescope, the alignment procedure advantageously identifies the likely astronomical object based on the first approximation alignment. The procedure also updates the first approximation alignment based on known information about the identified object. The process of user-direction to other viewable bright objects provides for ever more precise and accurate mappings of telescope movements to celestial field of view.

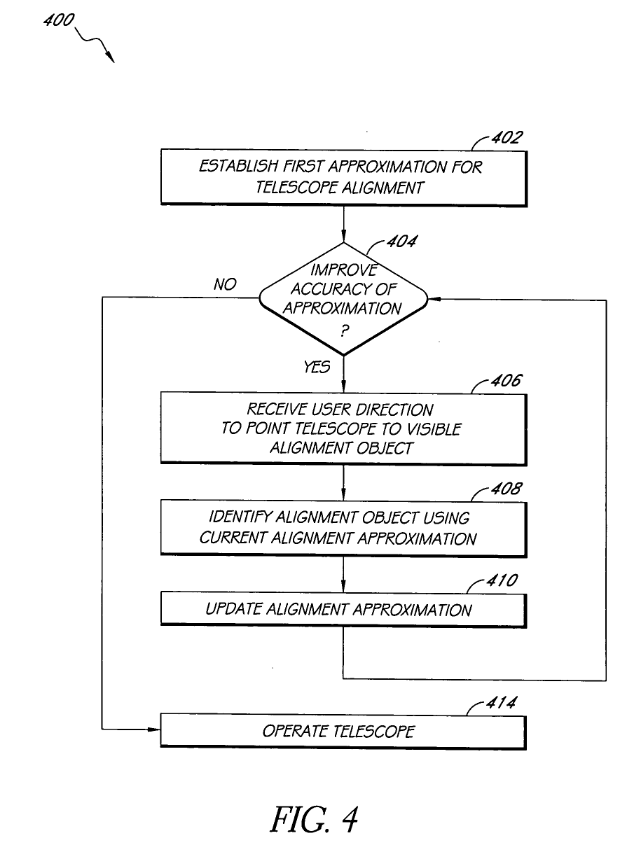

FIG. 4 is a flowchart that schematically illustrates one embodiment of a user-directed alignment process 400. In block 402, a first approximation for the alignment of the telescope is established. In some embodiments, the first approximation alignment is established by the process 300 described with reference to FIG. 3; however, any suitable telescope alignment method can be used. The telescope alignment in block 402 can be performed automatically or with various degrees of user participation. For example, the first approximation alignment in block 402 can include some or all of the steps of the automated refinement procedures described above (e.g., using alignment stars, images of alignment areas, drift alignment, etc.). Accordingly, the telescope alignment established in block 402 may be a relatively “coarse” alignment suitable for general astronomical observations or it may be relatively “fine” alignment suitable for longer exposure astrophotography.

At block 404, the user-directed alignment process 400 queries whether the accuracy of the current telescope alignment approximation should be improved by user-direction. If the user is satisfied with the accuracy of the alignment, the process 400 continues in block 414 wherein normal telescopic observations proceed, e.g., locating and/or tracking celestial objects, viewing and/or imaging celestial objects, etc. However, if the user wishes to improve the accuracy of the telescope alignment, the process 400 continues in block 406 wherein the user can direct the telescope to any suitable visible and sufficiently bright celestial object. In block 406, the user can provide varying amounts or degrees of control when directing the telescope to the alignment object. For example, in some embodiments, the user identifies a suitable bright object based on his or her knowledge of the night sky. Additionally and optionally, the user may consult sky maps, atlases, star charts, and the like to assist the user in identifying (and/or locating) a suitable object (e.g., a bright star in a constellation, a visible planet, a planetary nebula, a galaxy). For example, the sky map may be a printed sky map (e.g., available in many popular astronomy magazines) or it may be an electronic sky map available over the Internet or generated by astronomical software. In some embodiments, the sky map may be displayed on an A/V device in the display 216 of the control system 200 or on some other output device (e.g., a display on a computer, cell phone, or PDA). By viewing the night sky, the user can use his or her knowledge and/or other information to identify at least one viewable object that can be used as an alignment object.

In other embodiments, the control system 200 (or another astronomical software package) may suggest suitable alignment objects by querying the object database stored in the memory 208 and identifying likely candidate objects that are above the horizon at that time, date, and geographic location. In certain embodiments, the display 216 may output one or more of the suggested objects (e.g., via name or other identifying characteristics) by, for example, visually displaying a list on a monitor or screen or by audibly outputting sounds (e.g., from a voice synthesis module). The user may view the night sky to determine whether some or all of the suggested objects are in a suitably dark and unobstructed region of the sky. If the user determines that, for example, one of the suggested objects is suitably bright and accessible for telescope alignment, the user may then direct the telescope to the object.

A skilled artisan will recognize that a user can employ the above-described (or other) methods to identify a suitable alignment object. It is preferable, although not necessary, that the user-selected alignment object be reasonably bright, be in an unobstructed or unobstructed portion of the night sky, and be sufficiently above the horizon to avoid lights, trees, structures, etc. In some embodiments, it is desirable that the user-selected alignment object be in the general direction of the zenith (e.g., within about 30 degrees). By scanning the night sky, the user can select one or more suitable candidate alignment objects. As described above, the alignment object can be a star (including a double or multiple star), a planet, a planetary satellite, an asteroid, a nebula (e.g., planetary or diffuse), a galaxy, or any other suitable astronomical object.

In accordance with a preferred embodiment, the user then directs the telescope to the user-selected alignment object by moving the telescope tube 12 so that its field of view includes the alignment object. For example, the user may utilize the hand-held system control unit 36 to cause the control system 200 to issue movement commands to the positioning system 212 (e.g., the altitude and azimuth motors) to slew the telescope to the user-selected object. However, in other telescope systems, the user may manually position the telescope tube towards the user-selected object, for example, by grasping and manipulating the telescope in altitude and azimuth directions.

The user then centers the alignment object in the field of view (e.g., by making small positional adjustments in altitude and azimuth). The user can observe the alignment object within the telescope's field of view by, for example, looking through the eyepiece 14. The eyepiece 14 may include reticles, cross hairs, grids, scales, or other indicia to assist in centering the alignment object. In other embodiments, the telescope system 10 may display an image of the field of view on, for example, the display 216. Similarly to the eyepiece 14, the image display may also include indicia to assist centering the object in the field of view.

When the user-selected alignment object is centered to sufficient accuracy, the user sends a command to the control system 200 (e.g., by pressing a button on the hand-held control unit 36). The control system 200 can receive data from the positioning system 212 (e.g., information from axis and/or motor encoders) indicating the centered position of the object with respect to the telescope coordinate system.

In block 408, the alignment object centered in the telescope's field of view is identified and its celestial coordinates (e.g., RA and declination) are determined. In some embodiments, the control system 200 estimates the object's celestial coordinates based on the current alignment approximation of the telescope. For example, based on the current telescope alignment the control system 200 converts or transforms the telescope coordinates (e.g., altitude and azimuth) into estimated celestial coordinates for the object. In a preferred embodiment, the control system 200 compares the estimated celestial coordinates with known coordinates in the object database stored in the memory 208 so as to identify one or more candidate objects that may correspond to the object centered within the telescope's field of view. In many cases there will be only one likely candidate. In cases where there are several candidates, the control system 200 can use any of several well-known algorithms to identify a “best” candidate. For example, the system 200 may select the candidate object closest to the estimated celestial coordinates (e.g., having the smallest angular separation), or the brightest of the candidate objects within a predetermined angular distance from the estimated celestial coordinates. In other embodiments, the control system 200 may establish a preference hierarchy wherein, for example, a candidate planet is selected over a candidate star, a candidate star is selected over a candidate nebula, and so forth. The control system 200 may utilize one or more or a combination of the above algorithms to identify the best candidate.

In other embodiments, different algorithms can be used to identify the user-selected object. For example, in an embodiment, if there are several likely candidates, the control system 200 outputs a list of the candidates (e.g., on the display 216), and the user can select the most appropriate candidate. For example, the candidates may include a star and a galaxy, and the user, knowing that he or she is observing a star, can select the star. In certain embodiments, the control system 200 provides for additional user input or even manual override in the identification act in block 408. For example, the user may know the name, catalog number, the celestial coordinates, or other identifying characteristics of the user-identified alignment object. The user can input some or all of this information into the control system 200 (e.g., via the input devices in the display 216 and/or other input devices connected wired or wirelessly through the I/O ports 220). In the case where the user inputs celestial coordinates of the alignment object, the control system 200 does not need to further identify the object. In cases where the user inputs a name, catalog number, etc., the control system 200 queries the object database stored in the memory 208 to lookup the object's celestial coordinates. Embodiments that provide for user direction in the identification act (block 408) beneficially utilize the user's astronomical knowledge and observing experience and further involve the user in the “hands on” alignment process 400.

Because there are fewer bright objects than faint objects in the sky, the control system 200 (in block 408) generally will more accurately be able to identify an alignment object if the user selects a reasonably bright object. Accordingly, it is preferable, but not necessary, for the user-selected alignment object to be a bright object viewable from the location of the telescope system 10 (e.g., not blocked or interfered with by trees, structures, terrain, lights, etc.). However, the user-directed alignment process 400 is not limited to bright objects, and in other embodiments, the user may select as an alignment object any object with known celestial coordinates (e.g., any object in the object database stored in the memory 208). For example, in one embodiment, after performing the first approximation alignment (block 402), the user may direct the telescope control system 200 to move the telescope tube 12 toward a celestial object that the user desires to view and/or image. After the user centers the desired object within the field of view, the control system 200 can identify the object and determine (or update) the mapping between telescope coordinates and celestial coordinates. Advantageously, in such embodiments, the control system 200 determines the mapping while the user substantially simultaneously is able to observe the desired celestial object. Accordingly, such embodiments beneficially reduce the delay between telescope setup and normal telescope operations, because the user-selected alignment object is the same as the user's first desired observing object.

In the embodiment shown in FIG. 4, after the user-directed alignment process 400 completes blocks 406 and 408, the control system 200 has information relating to both the telescope coordinates and the celestial coordinates of the user-identified alignment object. In block 410 the process 400 uses this information to update the approximate alignment of the telescope. A skilled artisan will recognize that the control process 200 can implement many well-known algorithms to perform a refinement of the conversion between telescope and celestial coordinates. After the telescope alignment approximation has been updated in block 410, the process 400 returns to block 404 and again queries the user whether the alignment needs further refinement. Blocks 404-410 can be repeated as many times as need to provide a sufficiently accurate and precise telescope alignment.

In some embodiments, in block 404 the control system 200 queries the user regarding his subjective impressions of the telescope alignment. For example, the user may be presented with a simple “yes-no” choice regarding whether to proceed with an additional alignment object. If the user is happy with the current alignment, the user selects “no” and begins the evening's observations. However, in other embodiments, the control system 200 outputs information relating to the accuracy and/or the precision of the alignment at that stage of the process 400. The user can utilize this information in making the response to the query in block 404. For example, this information may include one or more quantitative measures or estimates of the accuracy of the telescope alignment. The quantitative measures may reflect, for example, a statistical “goodness of fit” of the coordinate conversion, an error budget indicating degree of mismatch between the two coordinate systems, or any other suitable metric. In certain embodiments, the control system 200 suggests alignment objects that are most likely to increase the accuracy of the coordinate conversion. For example, selection of a second alignment object that is located a reasonable angular distance away from a first alignment object (e.g., greater than about 30 degrees) may increase the accuracy of the update procedure in block 410 more than the selection of a second object that is very close to the first (e.g., within a few degrees). The user may direct the process 400 to repeat blocks 406-410 until quantitative and/or subjective measures indicate that a sufficiently accurate telescope alignment has been achieved.

When the accuracy of the approximate telescope alignment is adequate, the process 400 continues in block 414 which is normal telescope operation (e.g., slewing, tracking, viewing, imaging, etc.). For example, the user can continue viewing the user-selected alignment object, direct the telescope to a new object, or utilize the control software to suggest or find interesting objects from the object database stored in the memory 208. Because the telescope has been accurately aligned by the process 400, the control system 200 can automatically point the field of view of the telescope tube 12 toward any desired celestial object or celestial coordinate position. Additionally, information determined from the alignment process (e.g., observer latitude and local hour angle) can be used by the control system 200 to drive the motors in the positioning system 212 so as to track celestial objects at the sidereal rate. Accordingly, the control system 200 can “stop the sky” and permit longer time viewing (or imaging) of celestial objects. Further details for using azimuth and altitude drive rate equations to track celestial objects are taught, for example, in the above-incorporated U.S. Pat. No. 6,392,799.

The user-directed telescope alignment process disclosed herein (such as the example process 400) has additional advantages. For example, telescope alignment may deteriorate during the course of an observing session due to, e.g., mechanical slippages in the positioning system 212, small displacements of the telescope system 10 as a whole, thermal expansion/contraction effects, etc. If the user feels the alignment accuracy has been reduced, in certain embodiments, the control system 200 can be directed to perform the alignment process 400 wherein the current telescope alignment is used as the first approximation in block 402 (FIG. 4). The user can direct the telescope to as many alignment objects as needed to restore the telescope's alignment accuracy (e.g., by repeating blocks 404-410).

In other embodiments, the user-directed alignment system provides increasing or progressive telescope alignment over the course of an observing session. In these embodiments, the user establishes a first alignment, for example, by the process 300 (FIG. 3). The user (and/or the control system 200) directs the telescope to a first object, the user centers the object in the field of view and begins observing. The control system 200 receives the position of the object in telescope coordinates (e.g., from encoders in the positioning system 212) and determines the object's celestial coordinates by any of the methods described above with reference to block 408 in FIG. 4. Knowing both the telescope and celestial coordinates of the object, the system 200 can perform the alignment update of block 410 to refine the first approximate alignment. When the user (or the system 200) moves the telescope to a second object and the user centers the object, the control system 200 again updates and refines the telescope's alignment, and so on. Accordingly, as the user moves from object to object throughout the observing session, the telescope alignment will continue to be progressively updated. The progressive alignment system beneficially improves, or at least reduces the deterioration of, telescope alignment throughout the evening.

Although the systems and methods disclosed herein have been described with reference to an alt-azimuth telescope system, a skilled artisan will recognize that in other embodiments the disclosed user-directed alignment systems and methods may be used with equatorial or polar telescope systems. For example, additional details regarding alignment of polar telescope systems are taught in the above-incorporated U.S. Pat. No. 6,392,799.

While certain embodiments of the disclosure have been described, these embodiments have been presented by way of example only, and are not intended to limit the scope of the disclosure. Other embodiments will be apparent to those of ordinary skill in the art from the disclosure herein. Indeed, the novel methods and systems described herein may be embodied in a variety of other forms; furthermore, various combinations, modifications, omissions, substitutions, and changes in the form of the methods and systems described herein may be made without departing from the spirit of the disclosure. Furthermore, in any method or process disclosed herein, the acts or operations making up the method/process may be performed in any suitable order or sequence, and are not necessarily limited to any particular disclosed order/sequence. The accompanying claims and their equivalents are intended to cover such obvious or equivalent forms or modifications as would fall within the scope and spirit of the disclosure. Further, all publications, patents, and patent applications mentioned in this specification are herein incorporated by reference to the same extent as if each individual publication, patent, or patent application was specifically and individually indicated to be incorporated by reference.

What is claimed is:

1. A method of improving an alignment of a field of view of a telescope, the method comprising:
establishing a first approximation alignment of a field of view of a telescope system;
receiving an indication that a user has directed the field of view to an astronomical alignment object selected by the user from astronomical objects presently accessible;
electronically identifying celestial coordinates for the astronomical alignment object based on the first approximation alignment; and
electronically updating the first approximation alignment of the field of view based on the identified celestial coordinates.

2. The method of claim 1, wherein said user direction is performed manually by the user.

3. The method of claim 1, wherein said user direction is performed by a positioning system under the control of the user.

4. The method of claim 1, wherein said astronomical alignment object is bright.

5. The method of claim 1, wherein said electronically identifying celestial coordinates for the astronomical alignment object comprises:
electronically determining estimated celestial coordinates for the object based on the first approximation alignment;
electronically determining one or more candidate objects based on the estimated celestial coordinates;
electronically identifying one of the candidate objects as corresponding to the astronomical alignment object; and
electronically determining the celestial coordinates for the identified candidate.

6. The method of claim 5, wherein said electronically identifying one of the candidate objects comprises selecting the candidate object with celestial coordinates having the smallest angular distance from the estimated celestial coordinates.

7. The method of claim 5, wherein said electronically identifying one of the candidate objects comprises selecting the candidate object with the greatest apparent brightness within a predetermined distance from the estimated celestial coordinates.

8. The method of claim 1, wherein establishing a first approximation alignment comprises:
receiving date data indicative of an approximate current date;
receiving time data indicative of an approximate current time;
receiving location data indicative of an approximate current location of the telescope;
receiving a signal indicating the telescope being positioned approximately at horizontal or an angle with respect to horizontal; and
receiving a signal indicating the telescope being positioned approximately at a terrestrial direction or an angle with respect to the terrestrial direction.

9. A telescope system capable of user-directed alignment, the telescope system comprising:
an optical system including a field of view;
a positioning system adapted to precisely position the filed of view of the optical system; and
a processor configured to determine a first approximation alignment of the field of view, to receive an indication that a user has manipulated the positioning system to cause the field of view to be directed toward an astronomical alignment object selected by the user from astronomical objects presently accessible, to electronically identify celestial coordinates for the astronomical alignment object based on the first approximation alignment, and to electronically update the first approximation alignment of the field of view based on the identified celestial coordinates.

10. The telescope system of claim 9, wherein said positioning system comprises a manual positioning system.

11. The telescope system of claim 9, wherein said positioning system comprises an electronic positioning system under the control of the user.

12. The telescope system of claim 9, wherein said astronomical alignment object is bright.

13. The telescope system of claim 9, wherein said processor is also configured to electronically determine estimated celestial coordinates for the object based on the first approximation alignment, electronically determine one or more candidate objects based on the estimated celestial coordinates, electronically identify one of the candidate objects as corresponding to the astronomical alignment object, and electronically determine the celestial coordinates for the identified candidate.

14. The telescope system of claim 13, wherein said processor is also configured to select the candidate object with celestial coordinates having the smallest angular distance from the estimated celestial coordinates.

15. The telescope system of claim 13, wherein said processor is also configured to select the candidate object with the greatest apparent brightness within a predetermined distance from the estimated celestial coordinates.

16. The telescope system of claim 9, wherein said processor is also configured to receive date data indicative of an approximate current date, receive time data indicative of an approximate current time, receive location data indicative of an approximate current location of the telescope, receive a signal indicating the telescope being positioned approximately at horizontal or an angle with respect to horizontal, and receive a signal indicating the telescope being positioned approximately at a terrestrial direction or an angle with respect to the terrestrial direction.

17. A processing system capable of allowing a user to select an astronomical object from a database of astronomical objects and capable of directing a field of view of a telescope to view said astronomical object, said processing system comprising:
one or more inputs receiving an indication of precise movements of a field of view of a telescope system;
a user input; and
a processor configured to determine a first approximation alignment of the field of view, to receive an indication that a user has manipulated the positioning system to cause the field of view to be directed toward an astronomical alignment object selected by the user from astronomical objects presently accessible, to electronically identify celestial coordinates for the astronomical alignment object based on the first approximation alignment, to electronically update the first approximation alignment of the field of view based on the identified celestial coordinates, to receive a user selection of a desired astronomical object from a database of astronomical objects, and, using said updated first approximation alignment, to direct the field of view to view said desired astronomical object.

18. The processing system of claim 17, wherein said astronomical alignment object is bright.

19. A computer readable medium comprising software instructions capable of directing a processor of a telescope system including a field of view to update an alignment of a telescope, the software instructions comprising:
instructions that direct the processor to establish a first approximation alignment of the field of view of the telescope system;
instructions that direct the processor to receive an indication that a user has directed the field of view to an astronomical alignment object selected by the user from astronomical objects presently accessible;
instructions that direct the processor to electronically identify celestial coordinates for the astronomical alignment object based on the first approximation alignment; and
instructions that direct the processor to electronically update the first approximation alignment of the field of view based on the identified celestial coordinates.

20. The computer readable medium of claim 19, wherein said astronomical alignment object is bright.
